(19) United States
(12) Patent Application Publication
(10) Pub. No.: US 2025/0178465 A1
(43) Pub. Date: Jun. 5, 2025

(54) CONTROL DEVICE FOR LOCKING DEVICE

(71) Applicant: TOYOTA JIDOSHA KABUSHIKI KAISHA, Toyota-shi (JP)

(72) Inventor: Toru ANDO, Obu-shi (JP)

(73) Assignee: TOYOTA JIDOSHA KABUSHIKI KAISHA, Toyota-shi (JP)

(21) Appl. No.: 18/952,099

(22) Filed: Nov. 19, 2024

(30) Foreign Application Priority Data
Dec. 4, 2023 (JP) 2023-204481

(51) Int. Cl. B60L 53/16

(52) U.S. Cl. CPC B60L 53/16

(57) ABSTRACT

ECU is a control device for a lock mechanism that fixes a connector such as an AC power supply connector to an inlet of a vehicle. The connector includes an AC powered connector for powering an electric device external to the vehicle. When the lock mechanism is controlled to be switched to the unlocked state while the lock mechanism is in the locked state and the power supply is being performed, the power supply to the external electric device is stopped. ECU controls to switch the lock mechanism to the unlocked state when the first operation (the operation of satisfying the connector unlock condition at the time of non-power supply) is performed during the non-power supply in the locked state, and maintains the locked state of the locking device when the first operation is performed during the power supply in the locked state.

### CROSS-REFERENCE TO RELATED APPLICATION

This application claims priority to Japanese Patent Application No. 2023-204481 filed on Dec. 4, 2023, incorporated herein by reference in its entirety.

### BACKGROUND

### 1. Technical Field

The present disclosure relates to a control device for a locking device, and more particularly, to a control device for a locking device that fixes a connector to an inlet of a vehicle.

### 2. Description of Related Art

Conventionally, there has been a vehicle in which charging being performed is stopped when a charging connector is unlocked (see Japanese Unexamined Patent Application Publication No. 2020-141483 (JP 2020-141483 A), for example). In this vehicle, the connector is automatically locked again and charging is resumed, unless the connector is removed after being unlocked.

### SUMMARY

However, user convenience may be reduced if power supply is stopped, even if momentarily, when power is supplied from the vehicle to an external device.

The present disclosure has been made in order to address the above issue, and an object thereof is to provide a control device for a locking device capable of avoiding an unintended stop of power supply during power supply to an external device.

An aspect of the present disclosure provides a control device for a locking device that fixes a connector to an inlet of a vehicle.

The connector includes a connector that supplies power to an external device external to the vehicle.
Power supply to the external device is stopped when control is performed so as to switch the locking device to an unlocked state while power is supplied with the locking device in a locked state.

The control device is configured to
perform control so as to switch the locking device to the unlocked state when a first operation is performed while no power is supplied in the locked state, and
maintain the locking device in the locked state when the first operation is performed while power is supplied in the locked state.

According to such a configuration, when the first operation is performed while no power is supplied in the locked state, the locking device is switched to the unlocked state, and power supply to the external device is stopped. When the first operation is performed while power is supplied in the locked state, on the other hand, the locking device is maintained in the locked state, and thus power supply to the external device is not stopped. As a result, it is possible to provide a control device for a locking device capable of avoiding an unintended stop of power supply during power supply to an external device.

The control device may perform control so as to switch the locking device to the unlocked state when a second operation different from the first operation is performed while power is supplied in the locked state. According to such a configuration, the locking device can be switched to the unlocked state by determining that the user has an intention to stop power supply and switch the locking device to the unlocked state, even while power is supplied, when the second operation different from the first operation is performed.

The control device may perform control so as to switch the locking device to the unlocked state when the first operation is performed a plurality of times while power is supplied in the locked state. According to such a configuration, it is determined that the user has an intention to stop power supply and switch the locking device to the unlocked state, even while power is supplied, when the first operation for switching the locking device to the unlocked state is performed a plurality of times while no power is supplied. Then, the locking device can be switched to the unlocked state.

The control device may execute a process of indicating an operation necessary to switch the locking device to the unlocked state when the first operation is performed while power is supplied in the locked state. According to such a configuration, the user can be informed of an operation necessary to switch the locking device to the unlocked state during power supply.

The control device may perform control so as to switch the locking device to the unlocked state when the second operation is performed while no power is supplied in the locked state. According to such a configuration, the locking device can be switched to the unlocked state, not only while power is supplied but also while no power is supplied, when the second operation is performed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of a vehicle in this embodiment;

FIG. 2 is a flowchart illustrating a flow of a connector unlock process in the first embodiment;

FIG. 3 is a flowchart illustrating a flow of a connector unlock process in the second embodiment;

FIG. 4 shows an example of a notification screen for notifying that a connector unlock condition during power supply is not satisfied but a connector unlock condition during non-power supply is satisfied;

FIG. 5 is a flow chart showing a flow of a connector unlock process in the third embodiment; and

FIG. 6 shows an example of a notification screen for receiving an operation of notifying that the connector unlock condition at the time of non-power supply is satisfied and confirming the user's intention to switch to the unlock state, although the connector unlock condition during power supply is not satisfied.

### DETAILED DESCRIPTION OF EMBODIMENTS

Hereinafter, an embodiment of the present disclosure will be described in detail with reference to the drawings. It should be noted that the same or corresponding parts in the drawings are designated by the same reference characters and repetitive description will be omitted.

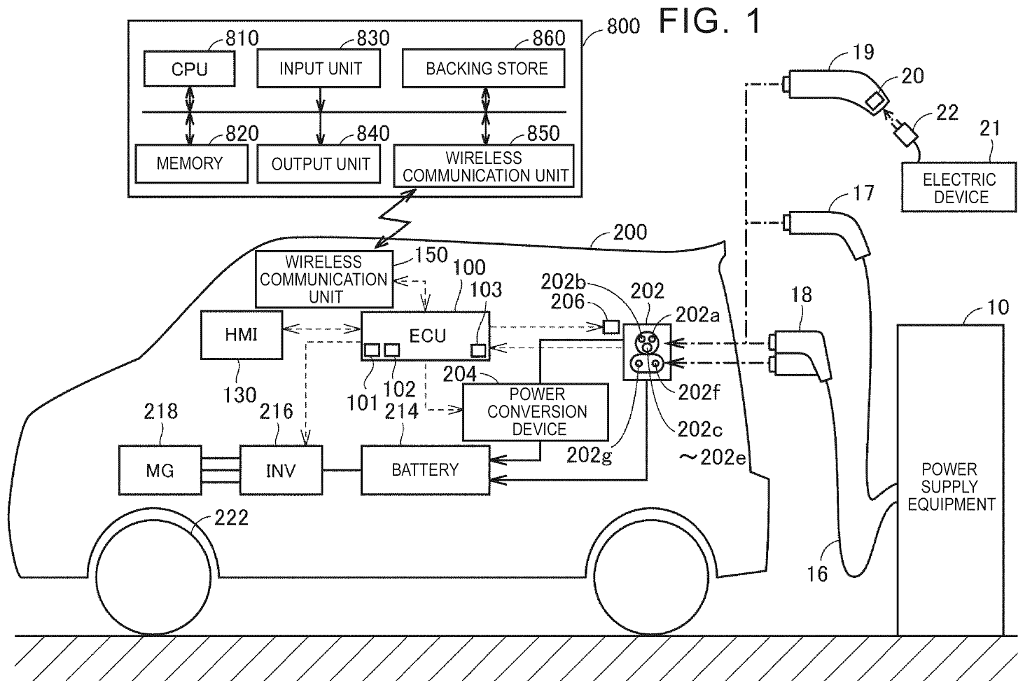

Hereinafter, a configuration of electrified vehicle 200 according to the present embodiment (hereinafter, referred to as vehicles) will be described. FIG. 1 is a diagram illustrating an example of a configuration of a vehicle 200 according to this embodiment. The vehicle 200 includes, for example, an electrified vehicle capable of exchanging electric power with electric devices outside the vehicle 200, such as a plug-in hybrid electric vehicle and a battery electric vehicle. In FIG. 1, for example, it is assumed that the vehicle 200 is parked in a parking space in which the power supply facility 10 is installed.

As illustrated in FIG. 1, the vehicle 200 includes an ECU (Electronic Control Unit) 100, an inlet 202, a power conversion device 204, a lock mechanism 206, a battery 214, an inverter 216, a motor generator (MG) 218, a HMI (Human Machine Interface) 130, and a wireless communication unit 150.

The motor generator 218 is, for example, a three-phase AC rotating electric machine, and has a function as an electric motor and a function as a generator. That is, the motor generator 218 exchanges electric power with the inverter 216.

For example, when the vehicle 200 is driven, the motor generator 218 applies a rotational force to the drive wheels 222 using electric power supplied from the inverter 216. The drive wheels 222 are rotated by a rotational force applied by the motor generator 218 to drive the vehicle 200. Note that the number of the motor generators 218 is not limited to one, and may be a plurality.

Inverter 216 bi-directionally converts power between motor generator 218 and battery 214 in response to control signals from ECU100. For example, when the motor generator 218 is driven, the inverter 216 converts the DC power of the battery 214 into AC power and supplies the AC power to the motor generator 218. The inverter 216 converts AC power (regenerative power) generated in the motor generator 218 into DC power and supplies the DC power to the battery 214 when the motor generator 218 generates power, for example. A converter that adjusts the voltage of the inverter 216 and the voltage of the battery 214 may be provided between the inverter 216 and the battery 214.

The battery 214 is, for example, a power storage element configured to be rechargeable, and typically a secondary battery such as a nickel metal hydride battery or a lithium-ion battery having a solid or liquid electrolyte is used. Alternatively, the battery 214 may be any power storage device capable of storing electric power, and for example, a large-capacity capacitor may be used instead of the battery 214.

The battery 214 is externally charged using electric power supplied from the power supply facility 10. External charging includes AC charging and DC charging. AC charging is charging using DC power supplied by converting AC power supplied from an external facility (power supply facility 10) to the inlet 202 in the power conversion device 204. DC charging is charging using DC power supplied from the power supply facility 10 to the inlet 202 without passing through the power conversion device 204.

The inlet 202 is provided on an exterior portion of the vehicle 200 together with a cover (not shown) such as a lid, and is configured to be attachable to various connectors to be described later. The inlet 202 is configured to be capable of transmitting and receiving electric power to and from equipment outside the vehicle 200 (hereinafter, referred to as external equipment). Here, “capable of exchanging electric power” indicates that at least one of charging and discharging is possible. That is, the inlet 202 can be supplied with electric power used for charging the battery 214 from an external facility. Further, the inlet 202 enables supply (discharge, power supply) of electric power of the battery 214 to an external facility.

The inlet 202 has a configuration that can be attached to any of AC charge connector 17 used for AC charge, DC charge connector 18 used for DC charge, and AC power supply connector 19 used for AC power supply. Note that AC power supply indicates an external power supply that supplies AC power from the vehicles 200 to an external facility (for example, the electric device 21). The inlet 202 is provided with AC connecting portions 202a, 202b, DC connecting portions 202f, 202g, and a 202e from the communication unit 202c.

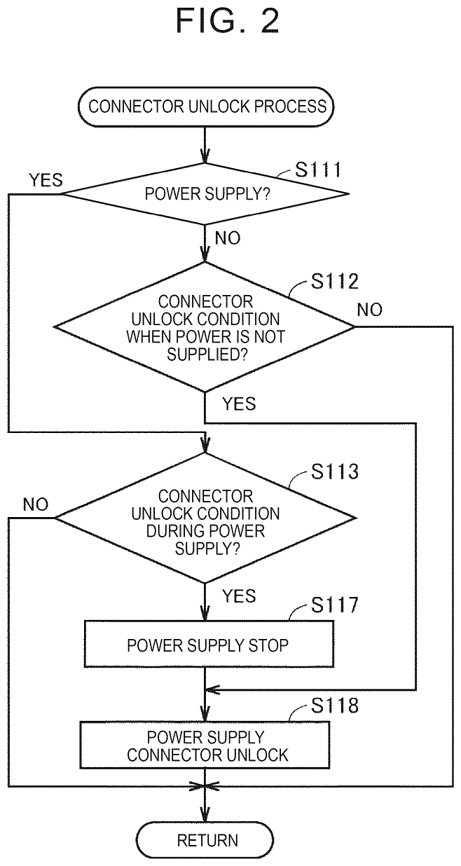

When AC charging connector 17 of the power supply facility 10 is attached to the inlet 202, AC connecting portion (see FIG. 2) of AC charging connector 17 is electrically connected to AC connecting portions 202a, 202b of the inlet 202, and the communication unit (see FIG. 2) of AC charging connector 17 is connected to 202e from the communication unit 202c of the inlet 202.

When DC charging connector 18 of the power supply facility 10 is attached to the inlet 202, AC connecting portion of DC charging connector 18 is electrically connected to AC connecting portions 202a, 202b of the inlet 202, and the communication unit of DC charging connector 18 is connected to 202e from the communication unit 202c of the inlet 202.

Further, when AC power supply connector 19 is attached to the inlet 202, AC connecting portion of AC power supply connector 19 is electrically connected to AC connecting portions 202a, 202b of the inlet 202, and the communication unit of AC power supply connector 19 is connected to the communication units 202c, 202d of the inlet 202. One end of AC power supply connector 19 is formed to be attachable to the inlet 202, and the other end of AC power supply connector 19 is provided with a socket 20. The socket 20 has a shape to which the plug 22 of the electric device 21 can be connected. The electric device 21 includes, for example, a household electrical appliance that operates in an AC100V.

The power conversion device 204 performs power conversion between the battery 214 and the inlet 202 in response to a control signal from ECU100. For example, when AC charging is performed on the battery 214 with AC charging connector 17 attached to the inlet 202, the power conversion device 204 converts AC power supplied from AC charging connector 17 into DC power. Then, the battery 214 is charged using the converted DC power.

Further, for example, when AC power supply connector 19 is attached to the inlet 202 and AC power supply using the battery 214 is performed while the plug 22 of the electric device 21 is connected to the socket 20 of AC power supply connector 19, the power conversion device 204 converts the DC power supplied from the battery 214 into AC power. Then, the converted AC power (for example, AC100V) is supplied to the electric device 21.

The lock mechanism 206 restricts the removal of the connector attached to the inlet 202 so as to be fixed to the inlet 202 (locked state). The lock mechanism 206 releases the restriction on the detachment of the connector to enable the detachment of the connector from the inlet 202 (unlocked state). The lock mechanism 206 is provided with an actuator. The actuator, for example, moves the member to a position that restricts movement of the connector in a state of being attached to the inlet 202 to a locked state, or moves the member to a position that allows movement of the connector in a state of being attached to the inlet 202 to an unlocked state. That is, the lock mechanism 206 switches from one of the locked state and the unlocked state to the other state in response to a control signal from ECU100.

ECU100 includes CPU (Central Processing Unit) 101 and memories (e.g., ROM (Read Only Memory), RAM (Random Access Memory)) 102 and interfaces 103. ECU100 controls each device (e.g., the power conversion device 204, the lock mechanism 206, or the inverter 216) by outputting a signal from the interface 103 so that the vehicle 200 is in a desired condition based on information such as a map and a program stored in the memory 102 and information from various sensors received by the interface 103. Note that various kinds of control performed by ECU100 are not limited to processing by software, and dedicated hardware (electronic circuitry) can be constructed and processed.

Further, when the connector (AC charge connector 17, DC charge connector 18, or AC power supply connector 19) is attached to the inlet 202, ECU100 executes a communication process of receiving predetermined data from the connector-side device (the power supply facility 10) at the interface 103. The predetermined information includes, for example, information on power that can be exchanged between the power supply facility 10 and the battery 214.

For example, when AC charge connector 17 is attached to the inlet 202, ECU100 receives predetermined data from the power supply facility 10 (more specifically, AC charge connector 17) at the interface 103. The predetermined information includes information indicating that the communication unit of AC charging connector 17 and the communication units 202c, 202d and 202e of the inlet 202 are connected, and the power exchanged between the attached AC charging connector 17 and the inlet 202 is AC power, and information indicating that the power exchanged between AC charging connector 17 and the inlet 202 is the charging power for charging the battery 214.

Alternatively, ECU100 may receive predetermined data at the interface 103 from the power supply facility 10 (more specifically, DC charge connector 18) when DC charge connector 18 is attached to the inlet 202, for example. The predetermined information includes information indicating that the communication unit of DC charging connector 18 and the communication units 202c, 202d and 202f of the inlet 202 are connected, and the power exchanged between DC charging connector 18 and the inlet 202 attached from the power supply facility 10 is DC power, and information indicating that the power exchanged between DC charging connector 18 and the inlet 202 is charging power.

Alternatively, for example, when AC power supply connector 19 is attached to the inlet 202, ECU100 receives predetermined data from AC power supply connector 19 at the interface 103. The predetermined information includes information indicating that the communication unit of AC power supply connector 19 and the communication units 202c, 202d of the inlet 202 are connected, and the power exchanged between the attached AC power supply connector 19 and the inlet 202 is AC power, and information indicating that the power exchanged between AC power supply connector 19 and the inlet 202 is the discharging power for discharging the battery 214.

When AC charge connector 17 of the power supply facility 10 is attached to the inlet 202 of the vehicle 200, the power supply facility 10 supplies AC power to the inlet 202. The AC power supplied to the inlet 202 is converted into DC power by the power conversion device 204. The converted DC power is supplied to the battery 214, and the battery 214 is charged.

When DC charge connector 18 of the power supply facility 10 is attached to the inlet 202 of the vehicle 200, the power supply facility 10 supplies DC power to the inlet 202. The DC power supplied to the inlet 202 is supplied to the battery 214 without passing through the power conversion device 204, and the battery 214 is charged.

HMI130 includes a touch panel display, and displays information received from ECU100 on the display, and transmits information received on the touch panel to ECU100.

The wireless communication unit 150 is controlled by ECU100 and receives wireless signals from other devices, for example, the terminal device 800, servers, or other vehicles 200. The wireless communication unit 150 converts the received wireless signal into data, stores the converted data in the memory 102, transmits the data to HMI130 for displaying the data, converts the data to be transmitted into a wireless signal, and transmits the wireless signal to another device of the data communication destination.

The terminal device 800 includes a CPU (Central Processing Unit) 810, a memory 820, an input unit 830, an output unit 840, a wireless communication unit 850, and an external storage device 860. CPU810, the memory 820, the input unit 830, the output unit 840, the wireless communication unit 850, and the external storage device 860 are connected to each other by a bus.

The memories 820 include a RAM (Random Access Memory) used as a working area required to execute a program in a CPU810, and a ROM (Read Only Memory) for storing a program to be executed in a CPU810. In RAM, programs and data for executing predetermined processes are read from a ROM or the like and stored.

The input unit 830 includes a touch panel and operation buttons for inputting numbers such as telephone numbers and various data, alphabets, other characters, and the like. Note that the input unit 830 may include a portion for other operations. When the input unit 830 is operated by the user, an operation signal corresponding to the operation is transmitted from the input unit 830 in CPU810. CPU810 controls each unit of the terminal device 800 in response to an operation signal from the input unit 830.

The output unit 840 includes a display and a speaker. The display is integrally formed with the touch panel. The output unit 840 is controlled by a CPU810. The output unit 840 causes the display to display the information received by the wireless communication unit 850, the information stored in the memory 820, or the image signal and the audio signal obtained by converting the information read from the recording medium by the external storage device 860 by CPU810, as an image, and causes the speaker to output the image signal and the audio signal as an audio.

The wireless communication unit 850 is controlled by CPU810 and receives wireless signals from the other terminal device 800 or the fixed telephone of the communication partner via the public line and the antenna. The wireless communication unit 850 converts the received wireless signal into an audio signal, and transmits the converted audio signal to the audio input/output unit. The wireless communication unit 850 converts a voice signal from the voice input/output unit into a wireless signal, and transmits the wireless signal to another terminal device 800 of the communication partner or a fixed telephone via the antenna and the communication facility of the telecommunication carrier.

Further, the wireless communication unit 850 is controlled by a CPU810 to receive wireless signals from devices capable of data communication, for example, vehicles 200, servers, or other terminal devices 800, via a public line and an antenna. The wireless communication unit 850 converts the received wireless signal into data, stores the converted data in the memory 820, and transmits the converted data to the output unit 840 for displaying the data. The wireless communication unit 850 converts the data to be transmitted into a wireless signal, and transmits the wireless signal to the vehicle 200, the server, or the other terminal device 800 of the data communication destination via the antenna and the communication facility of the telecommunication carrier.

The external storage device 860 includes a memory card reader/writer. The external storage device 860 electrically records predetermined data or programs received from CPU810 on a recording medium such as a memory card or a USB (Universal Serial Bus), reads the data from the recording medium, and transfers the data to CPU810. The external storage device 860 may be configured by a storage device such as a hard disk drive, a flexible disk drive, a MO (Magneto-Optical disk) drive, a CD (Compact Disc) drive, or a DVD (Digital Versatile Disk) drive.

CPU810 executes predetermined processing in accordance with programs and data stored in the storage medium of the memory 820 or the external storage device 860, and processes data input from the input unit 830 or the wireless communication unit 850. CPU810 stores the processed data in the memory 820, outputs the processed data from the wireless communication unit 850 to another device, and stores the processed data in a recording medium of the external storage device 860.

Note that, although the terminal device 800 has been described as being a portable terminal such as a smart phone, the present disclosure is not limited thereto, and may be another information processing device such as a PC (Personal Computer) or a tablet.

In the above-described vehicles 200, charging or power supply may be stopped when AC charging connector 17, DC charging connector 18, or AC power supply connector 19 is unlocked. If AC charging connector 17, DC charging connector 18, or AC power supply connector 19 is not removed after being unlocked, it is conceivable that the charging is automatically re-locked and the charging is resumed. As described above, in the electric device 21, even if the power supply is resumed, a resumption operation is necessary, or it is difficult to temporarily stop the operation.

However, in particular, when power is being supplied, when power is being supplied from the vehicle 200 to the external electric device 21, if the power supply is stopped even if the power supply is temporary, there is a possibility that the convenience of the user is deteriorated. For example, when the door is unlocked in order to take something that is placed in the vehicle while cooking rice in the rice cooker as the external electric device 21, even if the power supply is automatically resumed when the power supply is stopped, the rice cooking is stopped on the way, so that delicious rice cannot be cooked.

Therefore, when the lock mechanism 206 is controlled to switch the lock mechanism 206 to the unlocked state during the power supply in the locked state, when the power supply to the external electric device 21 is stopped, ECU100 performs control to switch the lock mechanism 206 to the unlocked state when the first operation is performed during the non-power supply in the locked state. In addition, ECU100 maintains the locked state of the lock mechanism 206 when the first manipulation is performed while the power is being supplied in the locked state.

Thus, when the first operation is performed during the non-power supply in the locked state, the lock mechanism 206 is switched to the unlocked state, and the power supply to the external electric device 21 is stopped. On the other hand, when the first operation is performed during the power supply in the locked state, the locked state of the lock mechanism 206 is maintained, and thus the power supply to the external electric device 21 is not stopped. As a result, it is possible to avoid the unintended stoppage of the power supply during the power supply to the external electric device 21.

### First Embodiment

FIG. 2 is a flowchart illustrating a flow of a connector unlock process in the first embodiment. Referring to FIG. 2, the connector unlock process is called at predetermined intervals from the higher-order process by CPU101 of ECU100 and is executed. CPU101 determines whether or not power is being supplied (S111).

If it is determined that power is not being supplied (NO in S111), that is, it is not being supplied with power, CPU101 determines whether or not the connector unlock condition at the time of non-power supply is satisfied (S112). The connector unlock condition at the time of non-power supply may be, for example, a condition that an unlock operation of the door of the vehicle 200 (for example, an operation of an unlock button of the door) is executed. The connector unlock condition at the time of non-power supply may be, for example, a condition that an unlock operation of the connector in the terminal device 800 is executed.

When it is determined that the connector unlock condition at the time of non-power supply is not satisfied (NO in S112), CPU101 returns the processing to be executed to the processing of the upper level of the caller of the connector unlock processing.

If it is determined that power is being supplied (YES in S111), CPU101 determines whether or not the connector unlock condition during power supply is satisfied (S113). The connector unlock condition during power supply is, for example, a condition that is less likely to be switched to an unlock state unintended by the user than the connector unlock condition during non-power supply. The connector unlock condition during power supply may be a condition different from the connector unlock condition at the time of non-power supply, for example, a condition that the unlock operation of the door of the vehicle is executed a predetermined number of times (for example, a plurality of times such as three times). The connector unlock condition during power supply may be the same condition as the connector unlock condition during non-power supply, for example, a condition that an unlock operation of the connector in the terminal device 800 is executed.

When it is determined that the connector unlock condition under power supply is not satisfied (NO in S113), CPU101 returns the processing to be executed to the processing of the upper level of the caller of the connector unlock processing.

When it is determined that the connector unlock condition under power supply is satisfied (YES in S113), CPU101 outputs a control signal for controlling the power conversion device 204 from the interface 103 so as to stop the power supply (S117).

If it is determined after S117 or that the connector unlock condition at the time of non-power supply is satisfied (YES in S112), CPU101 controls the lock mechanism 206 to switch AC power supply connector 19 to the unlock state (S118). After that, CPU101 returns the processing to be executed to the processing of the upper level of the caller of the connector unlock processing.

### Second Embodiment

In the above-described first embodiment, when the connector unlock condition during power supply is not satisfied during power supply, nothing is particularly performed. In the second embodiment, when the connector unlock condition during power supply is not satisfied during power supply, a predetermined process is executed.

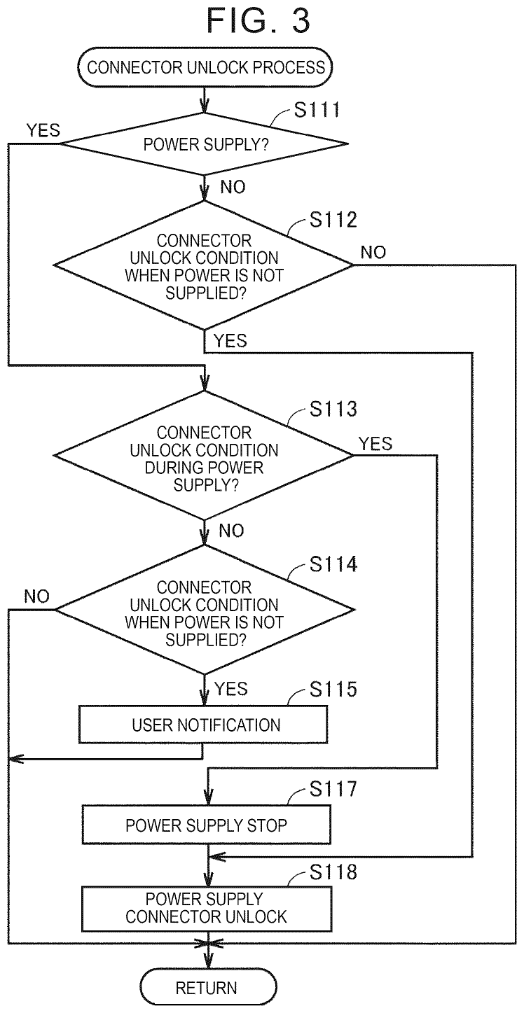

FIG. 3 is a flowchart illustrating a flow of a connector unlock process in the second embodiment. Referring to FIG. 3, the connector unlock process is called at predetermined intervals from the higher-order process by CPU101 of ECU100 and is executed. In the connector unlock processing in the second embodiment of FIG. 3, the same step numbers are given to the same processing as the connector unlock processing in the first embodiment of FIG. 2. In the second embodiment, portions different from those of the first embodiment will be described.

When it is determined that the connector unlock condition during power supply is not satisfied (NO in S113), CPU101 determines whether or not the connector unlock condition during non-power supply is satisfied (S114). When it is determined that the connector unlock condition at the time of non-power supply is satisfied (YES in S114), CPU101 controls the display of the output unit 840 so as to display a notification screen for notifying the user that the connector unlock condition at the time of non-power supply is satisfied although the connector unlock condition during power supply is not satisfied (S115).

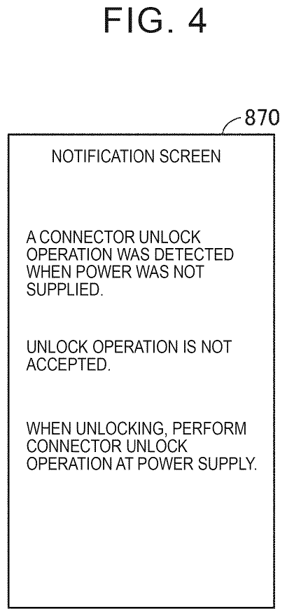

FIG. 4 shows an example of a notification screen for notifying that the connector unlock condition during power supply is not satisfied but the connector unlock condition during non-power supply is satisfied. The notification screen is displayed on the touch panel display 870 when a power supply application program (hereinafter referred to as an “application”) is executed in the terminal device 800. The touch panel display 870 includes the touch panel of the input unit 830 and the display of the output unit 840 of the terminal device 800.

In this notification screen, the connector unlock condition was not satisfied while the power was being supplied, but the connector unlock condition when the power was not supplied was satisfied, which means that “the connector unlock operation when the power was not supplied was detected.”, a sentence indicating that the unlock operation is not accepted, and a sentence indicating that an operation necessary for switching to the unlock state is notified are included.

Returning to FIG. 3, when CPU101 determines that the connector unlock condition at the time of non-power supply is not satisfied (NO in S114), or after S115, CPU101 returns the processing to be executed to the processing of the upper level of the caller of the connector unlock processing.

### Third Embodiment

In the above-described second embodiment, the connector unlock condition during power supply is not satisfied, but when the connector unlock condition during non-power supply is satisfied, the user is notified of this. In the third embodiment, an operation of confirming the intention of the user to switch to the unlocked state is accepted while notifying the fact.

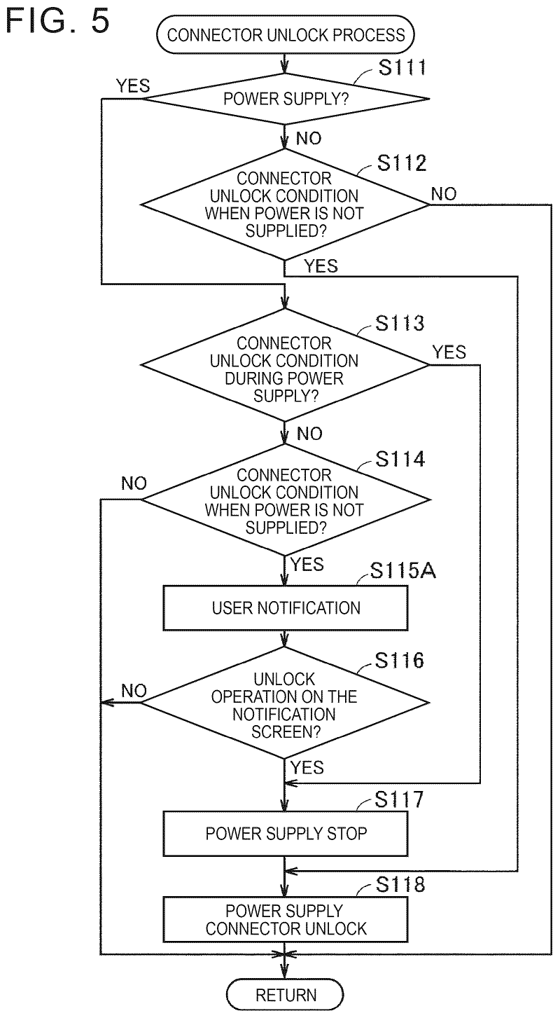

FIG. 5 is a flowchart illustrating a flow of a connector unlock process in the third embodiment. Referring to FIG. 5, the connector unlock process is called at predetermined intervals from the higher-order process by CPU101 of ECU100 and is executed. In the connector unlock processing in the third embodiment of FIG. 5, the same step numbers are given to the same processing as the connector unlock processing in the second embodiment of FIG. 3. In the third embodiment, portions different from those in the second embodiment will be described.

When it is determined that the connector unlock condition at the time of non-power supply is satisfied (YES in S114), CPU101 notifies the user that the connector unlock condition at the time of non-power supply is satisfied although the connector unlock condition during power supply is not satisfied. In addition, CPU101 controls the display of the output unit 840 to display a notification screen for accepting an operation of confirming the intention of the user to switch to the unlocked state (S115A).

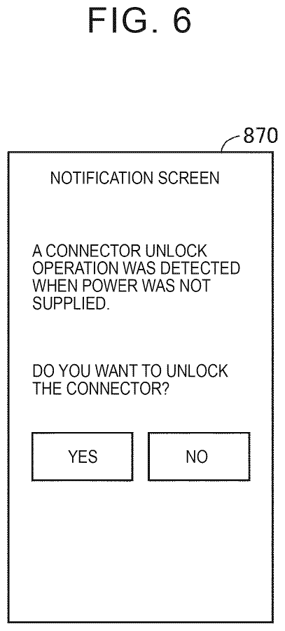

FIG. 6 shows an example of a notification screen for receiving an operation of notifying that the connector unlock condition at the time of non-power supply is satisfied and confirming the user's intention to switch to the unlock state, although the connector unlock condition during power supply is not satisfied. This notification screen is displayed on the touch panel display 870 of the terminal device 800.

In this notification screen, the connector unlock condition was not satisfied while the power was being supplied, but the connector unlock condition when the power was not supplied was satisfied, which means that “the connector unlock operation when the power was not supplied was detected.”, and a “yes” button and a “no” button for accepting an operation of confirming an intention of the user to switch the connector to the unlocked state are included.

Returning to FIG. 5, after S115A, CPU101 determines whether an unlock operation on the notification screen has been accepted (S116). When it is determined that the unlock operation has been accepted (YES in S116), that is, the “Yes” button has been operated in the notification window of FIG. 6, CPU101 executes S117 and subsequent processes described in the first embodiment.

On the other hand, when it is determined that the unlock operation has not been accepted (NO in S116), that is, the “No” button has been operated on the notification window of FIG. 6, CPU101 returns the processing to be executed to the processing of the upper level of the caller of the connector unlock processing.

### Modifications

(1) In the above-described embodiment, the notification screens illustrated in FIGS. 4 and 6 are displayed on the touch panel display 870 of the terminal device 800. However, the present disclosure is not limited thereto, and the confirmation window illustrated in FIGS. 4 and 6 may be displayed on HMI130 of another device, for example, the vehicles 200.

(2) Odor in the above-described embodiment, as shown in FIGS. 2, 3 and 5, when the connector unlock condition at the time of non-power supply is satisfied at the time of non-power supply, so as to unlock the connector at S118. However, the present disclosure is not limited thereto, and the connector may be unlocked not only when the connector unlock condition at the time of non-power supply is satisfied but also when the connector unlock condition during power supply is satisfied.

(3) The above-described embodiments can be regarded as disclosure of a control device of the vehicle 200 or the lock mechanism 206 such as an ECU100, can be regarded as disclosure of the vehicle 200 or the lock mechanism 206, and can be regarded as disclosure of a control method or a control program by a control device such as an ECU100.

### SUMMARY

(1) As shown in FIG. 1, ECU100 is a control device for a lock mechanism 206 that secures a connector, such as an AC power supply connector 19, to an inlet 202 of a vehicle 200. As shown in FIG. 1, the connector includes an AC power supply connector 19 for supplying power to an electric device 21 outside the vehicle 200. As illustrated in FIGS. 2, 3, and 5, when the lock mechanism 206 is controlled to switch the lock mechanism 206 to the unlocked state while power is supplied in the locked state, power supply to the external electric device 21 is stopped (for example, S117). As shown in FIGS. 2, 3, and 5, ECU100 controls to switch the lock mechanism 206 to the unlocked state when the first operation (for example, an operation of establishing the connector unlock condition at the time of non-power supply) is performed during the non-power supply in the locked state (for example, it is determined that the lock mechanism is YES in S112 and S118 is executed), and maintains the locked state of the locking device when the first operation is performed during the power supply in the locked state.

Thus, when the first operation is performed during the non-power supply in the locked state, the lock mechanism 206 is switched to the unlocked state, and the power supply to the external electric device 21 is stopped. On the other hand, when the first operation is performed during the power supply in the locked state, the locked state of the lock mechanism 206 is maintained, and thus the power supply to the external electric device 21 is not stopped. As a result, it is possible to avoid the unintended stoppage of the power supply during the power supply to the external electric device 21.

(2) As illustrated in FIGS. 2, 3, and 5, ECU100 may perform control to switch the lock mechanism 206 to the unlocked state when a second operation (for example, an operation of satisfying the connector unlock condition during power supply) that differs from the first operation is performed during power supply in the locked state (for example, S113 determines YES and S118 is executed). Thus, in the case where the second operation different from the first operation is performed, even if the power supply is being performed, it is determined that the user is willing to stop the power supply and switch the lock mechanism 206 to the unlocked state, and the state can be switched to the unlocked state.

(3) As illustrated in FIGS. 2, 3, and 5, ECU100 may be controlled to switch the lock mechanism 206 to the unlocked state when the first operation (for example, the door unlocking operation) is performed a plurality of times (for example, three times) while the power is supplied in the locked state (for example, S113 is determined to be YES and S118 is executed). Thus, when the first operation for switching to the unlocked state during the non-power supply is performed a plurality of times, even if the power supply is in progress, it is determined that the user is willing to stop the power supply and switch the lock mechanism 206 to the unlocked state, and the state can be switched to the unlocked state.

(4) As illustrated in FIGS. 3 to 6, when the first operation is performed while power is being supplied in the locked state, ECU100 may execute a process of notifying an operation required to switch the lock mechanism 206 to the unlocked state (for example, a process of displaying the notification screen of FIG. 4, a process of displaying a button for accepting the user's intention on the notification screen of FIG. 6). Accordingly, it is possible to notify the user of an operation necessary for switching to the unlocked state during power supply.

(5) The control device may control the lock mechanism 206 to switch to the unlocked state when the second operation is performed while the power is not supplied in the locked state. Thus, when the second operation is performed, the lock mechanism 206 can be switched to the unlocked state not only during power supply but also during non-power supply.

The embodiment disclosed herein shall be construed as exemplary and not restrictive in all respects. It is intended that the scope of the disclosure be defined by the appended claims rather than the description of the embodiments described above, and that all changes within the meaning and range of equivalency of the claims be embraced therein.

What is claimed is:

1. A control device for a locking device that fixes a connector to an inlet of a vehicle, wherein:
the connector includes a connector that supplies power to an external device external to the vehicle;
power supply to the external device is stopped when control is performed so as to switch the locking device to an unlocked state while power is supplied with the locking device in a locked state; and
the control device is configured to
perform control so as to switch the locking device to the unlocked state when a first operation is performed while no power is supplied in the locked state, and
maintain the locking device in the locked state when the first operation is performed while power is supplied in the locked state.

2. The control device for a locking device according to claim 1, wherein the control device performs control so as to switch the locking device to the unlocked state when a second operation different from the first operation is performed while power is supplied in the locked state.

3. The control device for a locking device according to claim 1, wherein the control device performs control so as to switch the locking device to the unlocked state when the first operation is performed a plurality of times while power is supplied in the locked state.

4. The control device for a locking device according to claim 1, wherein the control device executes a process of indicating an operation necessary to switch the locking device to the unlocked state when the first operation is performed while power is supplied in the locked state.

5. The control device for a locking device according to claim 2, wherein the control device performs control so as to switch the locking device to the unlocked state when the second operation is performed while no power is supplied in the locked state.
